(19) United States
(12) Patent Application Publication
(10) Pub. No.: US 2012/0069782 A1
(43) Pub. Date: Mar. 22, 2012

(54) METHOD AND APPARATUS FOR IMPROVING DRX IN A WIRELESS COMMUNICATION SYSTEM

(76) Inventors: Richard Lee-Chee Kuo, Taipei (TW); Yu-Hsuan Guo, Taipei (TW)

(21) Appl. No.: 13/232,192

(22) Filed: Sep. 14, 2011

Related U.S. Application Data
(60) Provisional application No. 61/385,337, filed on Sep. 22, 2010.

(51) Int. Cl. H04W 52/02

(52) U.S. Cl. 370/311

(57) ABSTRACT

A method and apparatus for handling discontinuous reception (DRX) configuration in a network of a wireless communication system includes configuring DRX cycles of a DRX function in a user equipment (UE) to include a first DRX cycle, a second DRX cycle having a value greater than a value of the first DRX cycle, and a third DRX cycle having a value greater than the value of the second DRX cycle for the UE to switch the DRX cycle between the first DRX cycle, the second DRX cycle and the third DRX cycle in a Radio Resource Control Connected (RRC_CONNECTED) mode.

### CROSS-REFERENCE TO RELATED APPLICATIONS

The present Application claims the benefit of U.S. Provisional Patent Application Ser. No. 61/385,337, tiled on Sep. 22, 2010, the entire disclosure of which is incorporated herein by reference.

### FIELD

This disclosure generally relates to wireless communication networks, and more particularly, to a method and apparatus for improving discontinuous reception (DRX) in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

According to one aspect, a method for handling DRX configuration in a network of a wireless communication system includes configuring DRX cycles of a DRX function in a user equipment (UE) to include a first DRX cycle, a second DRX cycle having a value greater than a value of the first DRX cycle, and a third DRX cycle having a value greater than the value of the second DRX cycle for the UE to switch the DRX cycle between the first DRX cycle, the second DRX cycle and the third DRX cycle in a Radio Resource Control Connected (RRC_CONNECTED) mode.

According to another aspect, a communication device for handling discontinuous reception (DRX) configuration in a network of a wireless communication system includes a control circuit, a processor installed in the control circuit, and a memory installed in the control circuit and coupled to the processor. The processor is configured to execute a program code stored in memory to provide DRX configuration to a user equipment (UE) by configuring DRX cycles of a DRX function in a UE to include a first DRX cycle, a second DRX cycle having a value greater than a value of the first DRX cycle, and a third DRX cycle having a value greater than the value of the second DRX cycle for the UE to switch the DRX cycle between the first DRX cycle, the second DRX cycle and the third DRX cycle in a Radio Resource Control Connected (RRC_CONNECTED) mode.

According to another aspect, signaling is sent to control UE switching the DRX cycle from the first DRX cycle or the second DRX cycle to the third DRX cycle. The signaling may be a Medium Access Control (MAC) Control Element or an RRC message.

According to another aspect, one or more parameters in a system information are used by the UE for the UE to determine the value of the third DRX cycle.

According to another aspect, one or more parameters in an RRCConnectionReconfiguration message by the UE for the UE to determine the value of the third DRX cycle.

According to another aspect, a method for a DRX function in a UE of a wireless communication system includes being configured by a network with DRX cycles of a DRX function including a first DRX cycle, a second DRX cycle with a value greater than a value of the first DRX cycle, and a third DRX cycle with a value greater than the value of the second DRX cycle; and switching the DRX cycle between the first DRX cycle, the second DRX cycle and the third DRX cycle in a RRC_CONNECTED mode.

According to another aspect, a communication device for handling DRX in a wireless communication system includes a control circuit, a processor installed in the control circuit, and a memory installed in the control circuit and coupled to the processor. The processor is configured to execute a program code stored in memory to perform the DRX function by being configured by a network with DRX cycles of a DRX function including a first DRX cycle, a second DRX cycle with a value greater than a value of the first DRX cycle, and a third DRX cycle with a value greater than the value of the second DRX cycle; and switching the DRX cycle between the first DRX cycle, the second DRX cycle and the third DRX cycle in a RRC_CONNECTED mode.

According to another aspect, the UE determines when to switch the DRX cycle from the first DRX cycle or the second DRX cycle to the third DRX cycle and then notifies the network of the DRX cycle switching. The UE may notify the network via a MAC Control Element or an RRC message.

According to another aspect, the UE receives signaling from the network to control switching the DRX cycle from the first DRX cycle or the second DRX cycle to the third DRX cycle. The signaling may be a MAC Control Element or an RRC message.

According to another aspect, the UE determines the value of the third DRX cycle by one or more parameters included in a system information.

According to another aspect, when the third DRX cycle is used, the UE starts onDurationTimer if [(SFN*10)+subframe number] modulo (defaultPagingCycle*10)=drxStartOffset.

According to another aspect, the value of the third DRX cycle is determined by one or more parameters included in an RRCConnectionReconfiguration message.

According to another aspect, upon switching to the third DRX cycle, the UE performs at least one of: (1) stopping at least one of drxInactivityTimer.drxShortCycleTimer, or onDurationTimer; (2) clearing any configured downlink assignments and uplink grants; (3) stopping Channel Quality Indicator, Precoding Matrix Index and Rank Indicator (CQI/PMI/RI) transmission; (4) stopping Sounding Reference Symbols (SRS) transmission: considering TimeAlignmentTimer as expired; and (6) resetting MAC.

### BRIEF DESCRIPTION OF THE DRAWINGS

FIG. 1 shows a diagram of a wireless communication system according to one exemplary embodiment.

FIG. 2 shows a user plane protocol stack of the wireless communication system of FIG. 1 according to one exemplary embodiment.

FIG. 3 shows a control plane protocol stack of the wireless communication system of FIG. 1 according to one exemplary embodiment.

FIG. 4 is a block diagram of a transmitter system (also known as access network) and a receiver system (also known as user equipment or UE) according to one exemplary embodiment.

FIG. 5 is a functional block diagram of a UE according to one exemplary embodiment.

FIG. 6 shows a method for improving DRX in a wireless communication system according to one exemplary embodiment.

FIG. 7 shows an exemplary embodiment of a method for DRX function in a UE of a wireless communication system.

FIG. 8 shows exemplary embodiments of switching between a first DRX cycle, a second DRX cycle and a third DRX cycle.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access ((OFDMA), 3GPP LIE (Long Term Evolution) wireless access, 3GPP LTE-A (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. 3GPP TS 36.300 V9.4.0, 3GPP TS 36.321 V9.3.0, 3GPP TS 36.331 V9.3.0, R2-104783. The standards and documents listed above are hereby expressly incorporated herein.

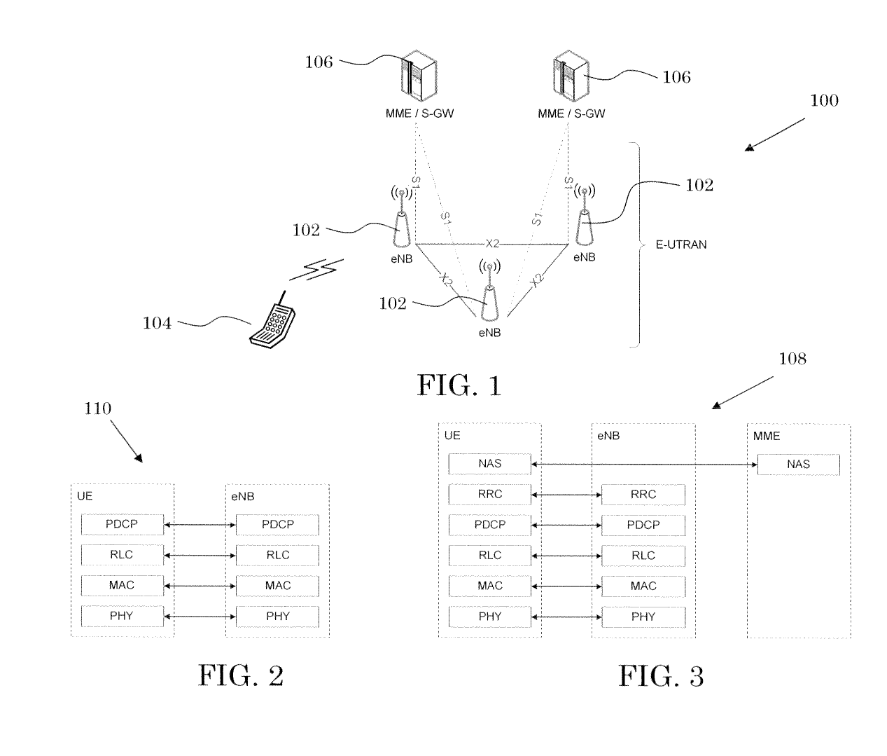

An exemplary network structure of an Evolved Universal Terrestrial Radio Access Network (E-UTRAN) 100 as a mobile communication system is shown in FIG. 1 according to one exemplary embodiment. The E-UTRAN system can also be referred to as a LTE (Long-Term Evolution) system or LTE-A (Long-Term Evolution Advanced). The E-UTRAN generally includes eNode B or eNB 102, which function similar to a base station in a mobile voice communication network. Each eNB is connected by X2 interfaces. The eNBs are connected to terminals or user equipment (UE) 104 through a radio interface, and are connected to Mobility Management Entities (MME) or Serving Gateway (S-GW) 106 through S1 interfaces.

Referring to FIGS. 2 and 3, the LTE system is divided into control plane 108 protocol stack (shown in FIG. 3) and user plane 110 protocol stack (shown in FIG. 2) according to one exemplary embodiment. The control plane performs a function of exchanging a control signal between a UE and an eNB and the user plane performs a function of transmitting user data between the UE and the eNB. Referring to FIGS. 2 and 3, both the control plane and the user plane include a Packet Data Convergence Protocol (PDCP) layer, a Radio Link Control (RLC) layer, a Medium Access Control (MAC) layer and a physical (PHY) layer. The control plane additionally includes a Radio Resource Control (RRC) layer. The control plane also includes a Non-Access Stratum (NAS) layer, which performs among other things including Evolved Packet System (EPS) bearer management, authentication, and security control.

The PHY layer provides information transmission service using a radio transmission technology and corresponds to a first layer of an open system interconnection (OSI) layer. The PHY layer is connected to the MAC layer through a transport channel. Data exchange between the MAC layer and the PHY layer is performed through the transport channel. The transport channel is defined by a scheme through which specific data are processed in the PHY layer.

The MAC layer performs the function of sending data transmitted from a RLC layer through a logical channel to the PHY layer through a proper transport channel and further performs the function of sending data transmitted from the PHY layer through a transport channel to the RLC layer through a proper logical channel. Further, the MAC layer inserts additional information into data received through the logical channel, analyzes the inserted additional information from data received through the transport channel to perform a proper operation and controls a random access operation.

The MAC layer and the RLC layer are connected to each o her through a logical channel. The RLC layer controls the setting and release of a logical channel and may operate in one of an acknowledged mode (AM) operation mode, an unacknowledged mode (UM) operation mode and a transparent mode (TM) operation mode. Generally, the RLC layer divides Service Data Unit (SDU) sent from an upper layer at a proper size and vice versa. Further, the RLC layer takes charge of an error correction function through an automatic retransmission request (ARQ).

The PDCP layer is disposed above the RLC layer and performs a header compression function of data transmitted in an IP packet form and a function of transmitting data without loss even when a Radio Network Controller (RNC) providing a service changes due to the movement of a UE.

The RRC layer is only defined in the control plane. The RRC layer controls logical channels, transport channels and physical channels in relation to establishment, re-configuration and release of Radio Bearers (RBs). Here, the RB signifies a service provided by the second layer of an OSI layer for data transmissions between the terminal and the E-UTRAN. If an RRC connection is established between the RRC layer of a UE and the RRC layer of the radio network, the UE is in the RRC_CONNECTED mode. Otherwise, the UE is in an RRC_IDLE mode.

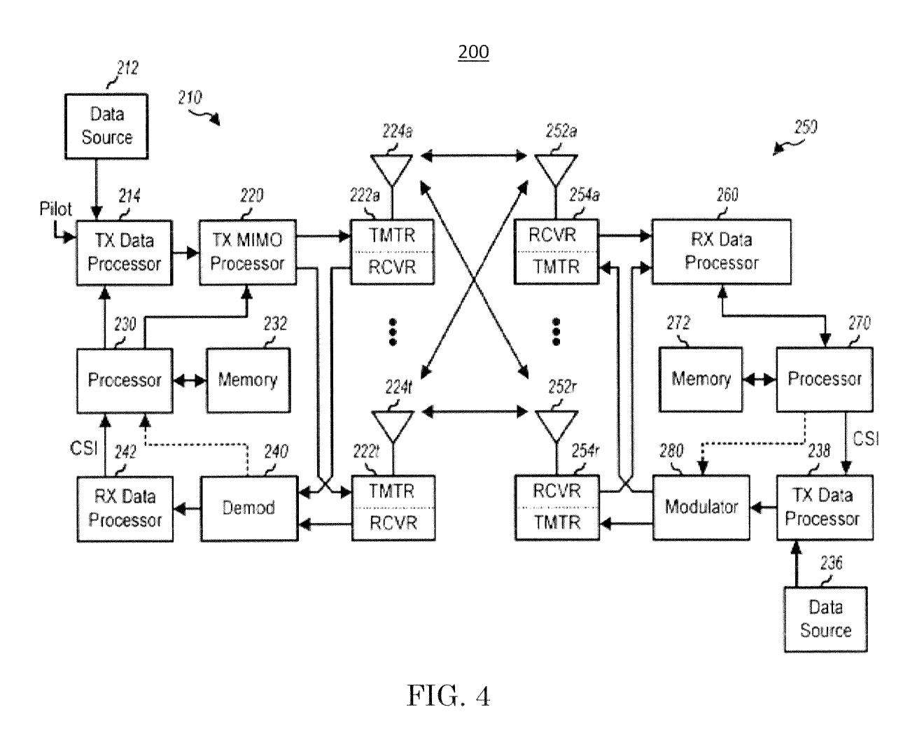

FIG. 4 is a simplified block diagram of an exemplary embodiment of a transmitter system 210 (also known as the access network) and a receiver system 250 (also known as access terminal or UE) in a MIMO system 200. At the transmitter system 210, traffic data for a number of data streams is provided from a data source 212 to a transmit (TX) data processor 214.

In one embodiment, each data stream is transmitted over a respective transmit antenna, TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beam forming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{T} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by e receiver system 250. Processor 230 then determines which pre-coding matrix to use for determining the beamforming weights then processes the extracted message.

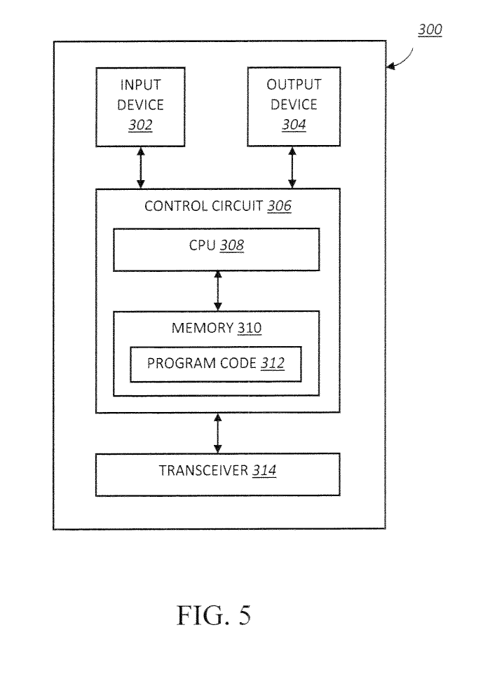

Turning to FIG. 5, this figure shows an alternative simplified functional block diagram of a communication device according to one exemplary embodiment. The communication device 300 in a wireless communication system can be utilized for realizing the UE 104 in FIG. 1, and the wireless communications system is preferably the LTE system, the LTE-A system or the like. The communication device 300 may include an input device 302, an output device 304, a control circuit 306, a central processing unit (CPU) 308, a memory 310, a program code 312, and a transceiver 314. The program code 312 includes the application layers and the layers of the control plane 108 and layers of user plane 110 as discussed above except the PHY layer. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit less signals, delivering received signals to the control circuit 306, and outputting signals generated by the control circuit 306 wirelessly.

The 3GPP LTE system uses a discontinuous reception (DRX) operation to reduce power consumption of a UE. The DRX operation refers to an operation in which to reduce power consumption of a UE, the UE wakes up at a predetermined cycle to receive downlink signaling, e.g. system information, paging messages or control signaling on a Physical Downlink Control Channel (PDCCH), transmitted from an eNB, and stops its reception operation for the rest of the time. The DRX operation is controlled at least by multiple timers, e.g. onDurationTimer, drxInactivityTimer, drxRetransmissionTimer, and drxShortCycleTimer, and signaling, e.g. DRX Command MAC Control Element. The details of the DRX operation are disclosed in 3GPP TS 36.321, V9.3.0. The state of a UE may be divided into an RRC_IDLE mode and a RRC_CONNECTED mode according to the RRC connection between the UE and the eNB. The RRC_IDLE mode is a state where the RRC connection is released, while the RRC_CONNECTED mode is a state where the RRC connection is established. When the DRX operation is configured in a RRC _CONNECTED mode, the UE discontinuously monitors a PDCCH. A DRX cycle specifies the periodic repetition of the On Duration followed by a possible period of not monitoring PDCCH by the UE. During On Duration, the UE should monitor PDCCH.

Currently, there are two DRX cycles in RRC_CONNECTED mode. The two DRX cycles are a Short DRX Cycle and a Long DRX Cycle. A UE switches from the Short DRX Cycle to Long DRX Cycle when a drxShortCycleTimer expires. The values of the Short DRX Cycle and the Long DRX Cycle are configured or reconfigured by eNB via an RRCConnectionReconfiguration message.

A UE may be running “always-on” type of applications, which can significantly reduce battery life. For instance, if a UE application periodically synchronizes entails, UE Access Stratum (AS) layer (layers below NAS layer are generally called AS layer) may know that after the synchronization, there will be no more user packet exchange and the RRC connection does not need to be kept via some communication between the application layer and the AS layer. However, as the network does not know this situation, the network will keep the UE in RRC_CONNECTED mode for a while until an implementation dependent timer expires.

If the UE decides to move to an RRC_IDLE mode, it may notify the network by a Signalling Connection Release Indication. However, if many UEs in the field use this kind of procedure, the network signalling overhead increases because the UE comes back to the RRC_CONNECTED mode at some point in time due to “always-on” applications and this requires signalling connection to eNB as well as to Evolved Packet Core (EPC).

Alternatively, the network can still have the control over the RRC connection and UE can go to power saving mode right away when the UE decides to go to power saving mode, Accordingly, the network decides how to handle the RRC connection when UE wants to go into the power saving mode. The UE can save power via a longer value of DRX cycle, Thus, a power saving can he achieved by applying the Long DRX cycle that is almost similar to the power savings achieved by moving the UE to RRC_IDLE. Therefore in order to save the UE power, the network should be able to decide either to keep the UE in RRC_CONNECTED mode with a longer value of DRX cycle or to release the RRC connection and move the UE to RRC_IDLE.

In order to save more UE power when a UE wants to enter power saving mode, e.g. dormancy state, and the eNB still wants to keep the UE in RRC_CONNECTED, the CE can use a longer value of DRX cycle. For the UE to use a value of DRX cycle in dormancy state that is longer than the value of Long DRX Cycle used before UE entering the dormancy state, eNB has to reconfigure the value of the Long DRX Cycle every time upon the transition between the dormancy state and a non-dormancy state. Such a transition creates large signalling overhead between UE and eNB.

As discussed above, the DRX cycle is switched between the Short DRX Cycle and the Long DRX Cycle in LTE. The Short DRX Cycle and the Long DRX Cycle are also referred to herein as the first DRX cycle and the second DRX cycle, respectively,

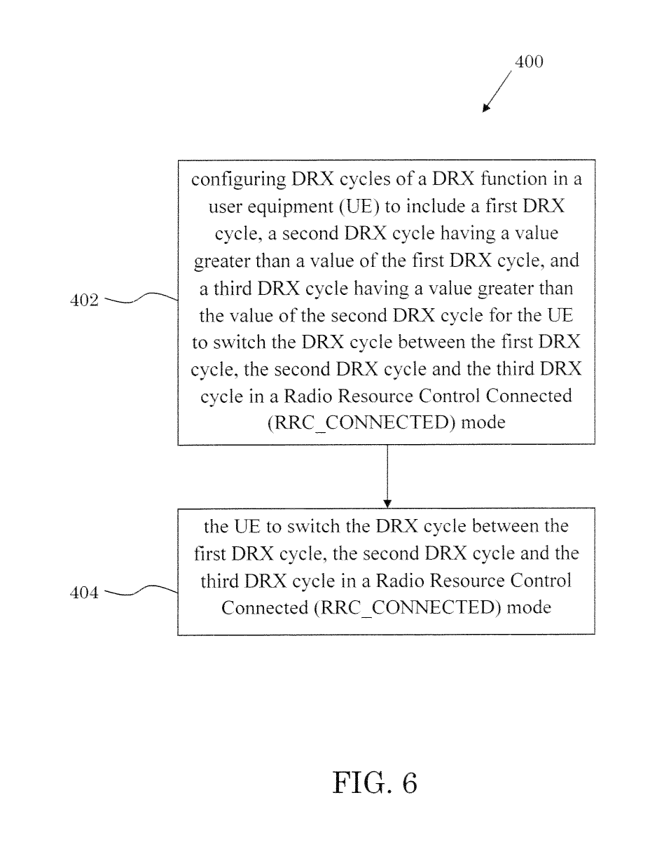

Referring to FIG. 6, an exemplary embodiment of a method 400 for handling DRX configuration in a network in a wireless communication system includes at 402 configuring DRX cycles of a DRX function in a user equipment (UE) to include a first DRX cycle, a second DRX cycle having a value greater than a value of the first DRX cycle, and a third DRX cycle having a value greater than the value of the second DRX cycle for the UE at 404 to switch the DRX cycle between the first DRX cycle, the second DRX cycle and the third DRX cycle in a Radio Resource Control Connected (RRC_CONNECTED) mode. According to the embodiment of FIG. 6, a third DRX cycle is defined, which is also referred to herein as the Dormancy DRX Cycle and which has a greater value than the value of the Long DRX Cycle to allow the UE to enter a dormancy state and still be in RRC_CONNECTED. Therefore, an eNB does not have to reconfigure the value of the Long DRX Cycle every time upon transition of the UE between the dormancy state and a non-dormancy state. The DRX cycle of the UE's DRX function can be simply switched to the Dormancy DRX Cycle from either the Short DRX Cycle or the Long DRX Cycle. Accordingly, not only signalling overhead associated with DRX reconfiguration is reduced, but also the UE battery power is conserved in the dormancy state while still being in RRC_CONNECTED.

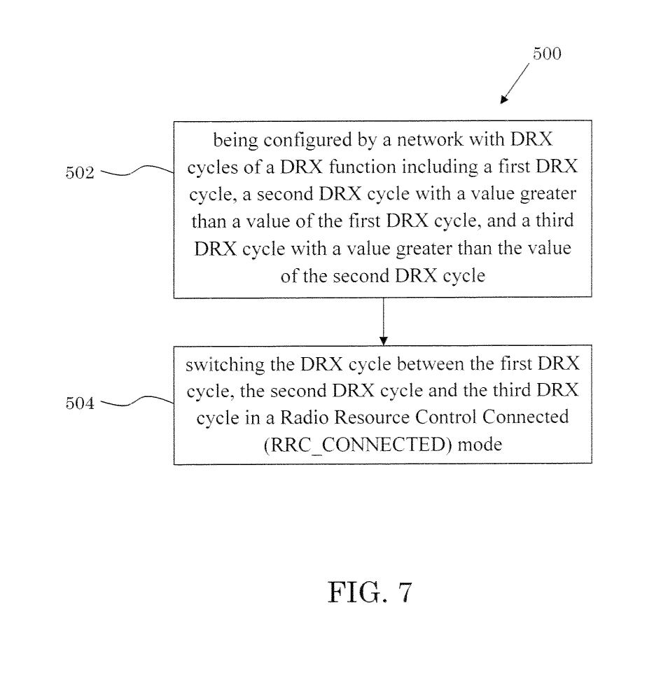

Referring to FIG. 7, an exemplary embodiment of a method 500 for DRX function in a UE of a wireless communication system is shown. The method 500 is similar in many ways to the method 400, except that it is for the UE while method 400 is for the network. The method 500 includes at 502 the UE being configured by a network with DRX cycles of a DRX function including a first DRX cycle, a second DRX cycle with a value greater than a value of the first DRX cycle, and a third DRX cycle with a value greater than the value of the second DRX cycle. The method 500 further includes at 504 the UE switching the DRX cycle between the first DRX cycle, the second DRX cycle and the third DRX cycle in a RRC_CONNECTED mode.

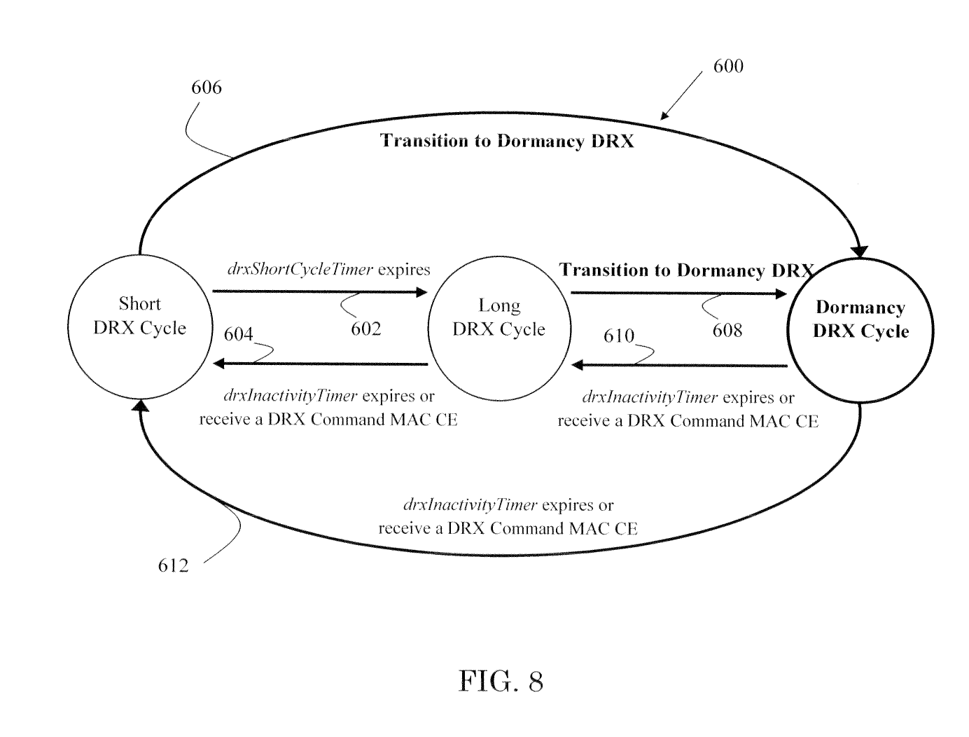

Referring to FIG. 8, exemplary embodiments of methods 600 of switching between the Short DRX Cycle, the Long DRX Cycle and the Dormancy DRX Cycle are shown. The UE may switch from the Short DRX Cycle to the Long DRX Cycle when drxShortCycleTimer expires as shown at 602. Conversely, the UE may switch from the Long DRX Cycle to the Short DRX Cycle when drxInactivityTimer expires or upon receiving a DRX Command MAC Control Element as shown in 604. As described in detail herein, the UE may transition to the Dormancy DRX Cycle from the Short DRX Cycle at 606 or from the Long DRX Cycle at 608. Conversely, the UE may switch from the Dormancy DRX Cycle to the Long DRX Cycle at 610 or the Short DRX Cycle at 612 when drxInactivityTimer expires or upon receiving a DRX Command MAC Control Element.

As described above, switching the DRX cycle from the Short DRX Cycle or the Long DRX Cycle to the Dormancy DRX Cycle would still keep UE in RRC_CONNECTED. Because the Dormancy DRX Cycle is a third DRX cycle that has a greater value than the value of the Long DRX Cycle, the value of the Long DRX Cycle does not need to be reconfigured when switching DRX cycle from Short DRX Cycle or Long DRX Cycle to Dormancy DRX Cycle. Similarly, switching the DRX cycle from Short DRX Cycle or Long DRX Cycle to the Dormancy DRX Cycle does not require reconfiguration of the value of Short DRX Cycle.

Switching the DRX cycle from e Short DRX Cycle or the Long DRX Cycle to the Dormancy DRX Cycle can be implicitly controlled by UE. In one embodiment, the UE indicates to the eNB that it wants to enter a dormancy state, and the UE can switch the DRX cycle to the Dormancy DRX Cycle. For example, when RRC layer of the UE submits a specific RRC message to a lower layer, the UE switches the DRX cycle to the Dormancy DRX Cycle. The specific RRC message may be a RRC Connection Release Request message or a RRC Connection Reconfiguration Request message.

Alternatively, switching the DRX cycle from the Short DRX Cycle or the Long DRX Cycle to the Dormancy DRX Cycle can be explicitly controlled by the eNB. In one embodiment, when receiving a specific MAC Control Element (CE), the UE can switch the DRX cycle to the Dormancy DRX Cycle. In another embodiment, when receiving a RRC message with a specific indication, e.g. an information element (IE), the UE switches the DRX cycle to the Dormancy DRX Cycle, The RRC message may be an RRCConnectionReconfiguration message.

The value of Dormancy DRX Cycle can be determined by one or more parameters broadcast in the system information, e.g. defaultPagingCycle in SystemInformationBlockType2. Alternatively, the value of Dormancy DRX Cycle can be determined by one or more parameters configured by an RRCConnectionReconfiguration message. When using the Dormancy DRX Cycle, the UE starts onDurationTimer if [(SFN*10)±subframe number] modulo (defaultPagingCycle*10)=drxStartOffset.

Upon switching to the Dormancy DRX Cycle, the UE could also perform some or all of the following: (1) stopping drxInactivityTimer and/or drxShortCycleTimer and/or onDurationTimer; (2) clearing any configured downlink assignments and uplink grants; (3) stopping Channel Quality Indicator, Precoding Matrix Index and Rank Indicator (CQI/PMI/RI) transmission; (4) stopping Sounding Reference Symbols (SRS) transmission; (5) considering TimeAlignmentTimer as expired; and (6) resetting MAC. For example, the UE may keep TimeAlignmentTimer running and scheduling request resource, but stop CQI/PMI/RI and SRS transmission.

Referring back to FIG. 5, which is a functional block diagram of a UE according to one exemplary embodiment, the UE 300 includes a program code 312 stored in memory 310. The CPU 308 executes the program code 312 to perform the steps of methods of the various embodiments described herein.

Various aspects of the disclosure have been described above. It should be apparent that the teachings herein may be embodied in a wide variety of forms and that any specific structure, function, or both being disclosed herein is merely representative. Based on the teachings herein one skilled in the an should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may he designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), m access terminal, or an access point. The IC may comprise a general purpose processor, a digital signal processor (DSP), an application specific integrated circuit (ASIC), a field programmable gate array (FPG_{A}) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may he any conventional processor, controller, microcontroller, or state machine. A processor may also be implemented as a combination of computing devices, e.g. a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to he limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials,

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for handling discontinuous reception (DRX) configuration in a network of a wireless communication system, the method comprising:
configuring DRX cycles of a DRX function in a user equipment (UE) to include a first DRX cycle, a second DRX cycle having a value greater than a value of the first DRX cycle, and a third DRX cycle having a value greater than the value of the second DRX cycle for the UE to switch the DRX cycle between the first DRX cycle, the second DRX cycle and the third DRX cycle in a Radio Resource Control Connected (RRC_CONNECTED) mode.

2. The method of claim 1, further comprising sending signaling to control UE switching the DRX cycle from the first DRX cycle or the second DRX cycle to the third DRX cycle.

3. The method of claim 2, wherein the signaling is a Medium Access Control (MAC) Control Element or an RRC message.

4. The method of claim 1, further comprising including one or more parameters in a system information for the UE to determine the value of the third DRX cycle.

5. The method of claim 1, further comprising including one or more parameters in an RRCConnectionReconfiguration message for the UE to determine the value of the third DRX cycle.

6. A communication device for handling discontinuous reception (DRX) configuration in a network of a wireless communication system, the communication device comprising:
a control circuit;
a processor installed in the control circuit; and
a memory installed in the control circuit and coupled to the processor;
wherein the processor is configured to execute a program code stored in memory to provide discontinuous reception (DRX) configuration to a user equipment (UE) by:
configuring DRX cycles of a DRX function in a UE to include a first DRX cycle, a second DRX cycle having a value greater than a value of the first DRX cycle, and a third DRX cycle having a value greater than the value of the second DRX cycle for the UE to switch the DRX cycle between the first DRX cycle, the second DRX cycle and the third DRX cycle in a Radio Resource Control Connected (RRC_CONNECTED) mode.

7. The device of claim 6, further comprising sending signaling to control UE switching the DRX cycle from the first DRX cycle or the second DRX cycle to the third DRX cycle.

8. The device of claim 7, wherein the signaling is a Medium Access Control (MAC) Control Element or an RRC message.

9. The device of claim 6, further comprising including one or more parameters in a system information for the UE to determine the value of the third DRX cycle.

10. The device of claim 6, further comprising including one or more parameters in an RRCConnectionReconfiguration message for the UE to determine the value of the third DRX cycle.

11. A method for discontinuous reception (DRX) function in a user equipment (UE) of a wireless communication system, the method comprising:
being configured by a network with DRX cycles of a DRX function including a first DRX cycle, a second DRX cycle with a value greater than a value of the first DRX cycle, and a third DRX cycle with a value greater than the value of the second DRX cycle; and
switching the DRX cycle between the first DRX cycle, the second DRX cycle and the third DRX cycle in a Radio Resource Control Connected (RRC_CONNECTED) mode.

12. The method of claim 11, further comprising the UE determining when to switch the DRX cycle from the first DRX cycle or the second DRX cycle to the third DRX cycle and then notifying the network of the DRX cycle switching.

13. The method of claim 12, wherein the UE notifies the network via a Medium Access Control (MAC) Control Element or an RRC message.

14. The method of claim 11, further comprising receiving a signaling from the network to control switching the DRX cycle from the first DRX cycle or the second DRX cycle to the third DRX cycle.

15. The method of claim 14, wherein the signaling is a Medium Access Control (MAC) Control Element or an RRC message.

16. The method of claim 11, further comprising determining the value of the third DRX cycle by one or more parameters included in a system information.

17. The method of claim 11, wherein when the third DRX cycle is used, the UE starts onDurationTimer if [(SFN*10)+subframe number] modulo (defaultPagingCycle*10) drxStartOffset.

18. The method of claim 11, further comprising determining the value of the third DRX cycle by one or more parameters included in an RRCConnectionReconfiguration message.

19. The method of claim 11, wherein upon switching to the third DRX cycle, the UE performs at least one of:
stopping at least one of drxInactivityTimer, drxShortCycleTimer, or onDurationTimer;
clearing any configured downlink assignments and uplink grants;
stopping Channel Quality Indicator, Precoding Matrix Index and Rank Indicator (CQI/PMI/RI) transmission;
stopping Sounding Reference Symbols (SRS) transmission;
considering TimeAlignmentTimer as expired; and
resetting Medium Access Control (MAC).

20. A communication device for handling discontinuous reception (DRX) in a wireless communication system, the communication device comprising:
a control circuit;
a processor installed in the control circuit; and
a memory installed in the control circuit and coupled to the processor;
wherein the processor is configured to execute a program code stored in memory to perform the DRX function by:
being configured by a network with DRX cycles of a DRX function including first DRX cycle, a second DRX cycle with a value greater than a value of the first DRX cycle, and a third DRX cycle with a value greater than the value of the second DRX cycle; and
switching the DRX cycle between the first DRX cycle, the second DRX cycle and the third DRX cycle in a Radio Resource Control Connected (RRC_CONNECTED) mode.

21. The device of claim 20, wherein the communication device determines when to switch the DRX cycle from the first DRX cycle or the second DRX cycle to the third DRX cycle and then notifies the network of the DRX cycle switching.

22. The device of claim 21, wherein the communication device notifies the network via a Medium Access Control (MAC) Control Element or an RRC message.

23. The device of claim 20, further comprising receiving a signaling from the network to control switching the DRX cycle from the first DRX cycle or the second DRX cycle to the third DRX cycle.

24. The device of claim 23, wherein the signaling is a Medium Access Control (MAC) Control Element or an RRC message.

25. The device of claim 20, the value of the third DRX cycle is determined by one or more parameters included in a system information.

26. The device of claim 20, wherein when the third DRX cycle is used, the communication device starts onDurationTimer if [(SFN*10)+subframe number] modulo (defaultPagingCycle*10)=drxStartOffset.

27. The device of claim 20, wherein the value of the third DRX cycle is determined by one or more parameters included in an RRCConnectionReconfiguration message.

28. The device of claim 20, wherein upon switching to the third DRX cycle, the communication device performs at least one of:
stopping at least one of drxInactivityTimer, drxShortCycleTimer, or onDurationTimer;
clearing any configured downlink assignments and uplink grants;
stopping Channel Quality Indicator, Precoding Matrix Index and Rank Indicator (CQI/PMI/RI) transmission;
stopping Sounding Reference Symbols (SRS) transmission;
considering TimeAlignmentTimer as expired; and
resetting Medium Access Control (MAC).
